(19) United States
(12) Patent Application Publication
(10) Pub. No.: US 2007/0166494 A1
(43) Pub. Date: Jul. 19, 2007

(54) Plastic foil for packages with barrier layer, in particular for food packaging

(76) Inventors: Martin Bergsmann, Linz (AT); Friedrich Kastner, Grieskirchen (AT); Johann Hilburger, Pirk (DE); Carl Stonley, Nottingham (GB)

Correspondence Address: WENDEROTH, LIND & PONACK, L.L.P., 2033 K STREET N. W., SUITE 800, WASHINGTON, DC, 20006-1021, US

(21) Appl. No.: 10/587,076

(22) PCT Filed: Feb. 15, 2005
(86) PCT No.: PCT/EP05/01504

§ 371 Date: Dec. 14, 2006

(30) Foreign Application Priority Data
Feb. 16, 2004 (AT) A 237/2004

(51) Int. Cl. B32B 15/085; B32B 27/32; B32B 1/02

(52) U.S. Cl. 428/35.9; 428/457; 428/523; 428/347; 428/461

(57) ABSTRACT

The invention concerns a plastic foil for packages designed for packaging cereals and cereal-based preparations. The invention is characterized in that said plastic foil consists of several layers among which one heat sealed layer, one HDPE layer and optionally one polypropylene layer, the opposite surface of the heat sealed layer being provided with a metal-coated barrier layer.

Packaging sheet, in particular for food items, with a barrier layer Food, in particular grain products or their preparations, are in general packaged in air- and gas-impermeable sheets, which, in addition, are impermeable to radiation and in particular to light. These packagings should in general also be impermeable to moisture in order to prevent the fast spoiling of the grain products or cereals, such as cornflakes, müsli, grain flake meals or their preparations, dried and/or roasted fruit or seeds and cores or kernels, such as nuts, pistachios, corn kernels, dried fruit and the like, or tuber crop preparations, such as potato chips and the like or analogous dried bulk goods.

However, a defined and selective air permeability, in particular oxygen permeability, must be ensured so that in the production, for example during the roasting of the products to be packaged, flavors and aromas can escape and the intrinsic flavor and aroma of the grain flake meals is not negatively affected.

The invention therefore has as its aim to provide a sheet material with metallic appearance for packaging grain flake products and their preparations, which has minimal moisture permeability and simultaneously a defined air permeability in order to increase the storage time, freshness and shelf life of these products.

Subject matter of the invention is therefore a packaging sheet, suitable for packaging grain products and their preparations, characterized in that the packaging sheet is comprised of a multilayered system comprised of a hot seal layer, a PE layer and, optionally, a polypropylene layer, the side facing away from the hot seal layer having a metallized barrier layer.

The hot seal layer can be a hot seal lacquer applied by means of conventional techniques, for example spraying, lacquering, vapor deposition, roll coating method, gravure printing, flexographic printing, screen printing, offset printing and digital printing and the like, a coextruded Surlyn layer already present on the PE sheet, or a layer comprised of LDPE, LLDPE, EVA, EAA, and the like. However, an ionomer is preferably utilized as a hot seal layer.

A coextrusion sheet is preferably utilized for the production of the packaging sheet, the PE core being provided on one side with a hot seal layer and, on the other side, with a polypropylene layer. The metallization is applied onto the polypropylene layer.

However, a PE sheet can also be laminated by means of a, for example, aqueous lamination adhesive with a polypropylene sheet, wherein the polypropylene sheet can already be metallized or it can be metallized subsequently. Onto the PE sheet a hot seal layer is applied.

However, it is also possible to utilize only a PE sheet, which, on one side, has a hot seal lacquer layer—applied for example by spraying, lacquering, vapor deposition, spreading, roll coating methods, gravure printing, flexographic printing, screen printing, offset and digital printing and the like—and, on the other side, has a metallization and the direct application of the metallization or the use of a primer for smoothing the surface is possible.

This production of the system via thin-film/lacquering technique offers the advantage that the properties of the total system can be controlled within a wide range. In particular the barrier properties can be set individually.

Feasible is also the use of a so-called duplex sheet (for example Surlyn/HDPE) with the hot seal layer being applied by extrusion.

The metallization must have sufficient gloss. According to the invention the specular reflection at 60° has a gloss value >40, preferably >60 (determined according to DIN 67530).

As the PE layers can be utilized HDPE, LDPE or LLDPE layers.

In spite of the nonpolar surface of the synthetic material, the metallization must have high adhesive strength so that it does not flake off during the production and the use of the packaging.

The carrier substrate is treated by means of an inline plasma (low pressure or atmospheric pressure plasma), corona or flame process. Through a high-energy plasmas, for example Ar or Ar/O₂ plasma the surface is purged of toning residues of the printing inks. The necessary sharp delimitation of the contours of the open-area clearances, required for the necessary precision of the coding, is obtained. The surface is simultaneously activated. Terminal polar groups are therein generated on the surface. The adhesion of metals and the like on the surface is thereby improved.

Simultaneously with the application of the plasma or corona or flame treatment, a thin metal or metal oxide layer can optionally be applied as an adhesion promoter, for example by sputtering or vapor deposition. Especially suitable are Cr, Al, Ag, Ti, Cu, TiO₂, Si oxides or chromium oxides. This adhesion promoting layer has in general a thickness of 0.1 nm-5 nm, preferably 0.2 nm-2 nm, especially preferred is a thickness of 0.2-1 nm.

The adhesion of the structured functional layer applied partially or over the entire surface is thereby further improved.

The metallization proper is subsequently applied. This layer is comprised of a metal, a metal compound, an alloy or an insulator. As the metal layer are suitable layers of Al, Fe, Ag, Cr and the like. Suitable alloys are for example Cu—Al alloys, Cu—Zn alloys and the like.

This layer can be applied using known methods, for example by vapor deposition, sputtering, printing (gravure printing, flexographic printing, screen printing, digital printing and the like), spraying, electroplating and the like. The thickness of the functional layer is 0.001 to 50 μm, preferably 0.1 to 20 μm.

In a preferred embodiment further functional layers are provided in the packaging sheet system. For example coatings with electrically conductive properties or microwave-absorbing coatings, for example metallic or polymeric conductive layers can be applied.

The electrically conductive coatings can therein be utilized for example for heating the package. The coatings can be applied over the entire surface or partially, for example in the form of a grid structure, in the form of lines or waves intersecting or overlapping one another.

Further, antibacterial coatings, for example Ag coatings, which may be produced by vapor deposition or by applying a lacquer with Ag particles, or germicidal color substances or lacquers with ingredients having antibacterial action, for example curcuma, can be applied.

For the production of a coating with radiation-absorbing, in particular microwave absorbing, or electrically conductive properties, color substances and lacquers with radiation-absorbing or electrically conductive pigments, for example graphite, carbon black, conductive organic or inorganic polymers, metal pigments (for example copper, aluminum, silver, gold, iron, chromium and the like), metal alloys such as copper-zinc or copper-aluminum or also amorphous or crystalline ceramic pigments such as ITO, FTO, ATO and the like can be utilized. Further, can also be utilized as additives doped or non-doped semiconductors such as for example silicon, germanium, gallium arsenide, or ion conductors such as amorphous or crystalline metal oxides or metal sulfides. For the control of the electric properties of the layer can further be utilized or added polar or partially polar compounds such as tensides, or nonpolar compounds such as silicon additives or hygroscopic or non-hygroscopic salts. Intrinsically conductive organic polymers such as polyaniline, polyacetylene, polyethylene dioxythiophene and/or polystyrene sulfonate can also be added.

The optical properties of the layer can be affected by visible color substances or pigments, luminescent coloring substances or pigments, which fluoresce or phosphoresce in the visible, the UV range or in the IR range, heat-sensitive inks or pigments, effect pigments, such as liquid crystals, pearlescent pigments, bronzes and/or multilayer color change pigments. These can be applied in all conceivable combinations.

A layer can further also have optically active properties. Here can be considered for example diffraction structures, diffractive structures, holograms, surface reliefs and the like, which optionally can be partially metallized.

These structures are preferably introduced into thermoplastic or UV-curing layers.

For the protection of the metallization the packaging material can also be preferably provided with a protective lacquer layer, for example with a layer based on cellulose or its derivatives. This protective lacquer layer has good oxygen or air transmission and can optionally be set to be microporous by adding pore-forming pigments. The protective lacquer layer based on cellulose or its derivatives, for example nitrocellulose, is highly transparent, scratch and crease-resistant and has good adhesion on the metallized layer. The protective lacquer can also be only partially imprinted, for example as a dot or line raster or with open-area clearances. Via the ratio of imprinted and nonimprinted areas the transmission of oxygen or odorous substances can be set. The protective lacquer can also be structures by means of laser, through ion or electron etching or by means of mechanical perforation.

Instead of a protective lacquer, an oxide layer can also be applied for the protection of the metallization, for example an SiO₂ or an Al₂O₃ layer.

The protective lacquer layer, in addition, has excellent imprintability.

The protective lacquer layer can optionally also be provided with antibacterial additives.

This layer can be applied with known methods, for example by printing (gravure printing, flexographic printing, screen printing, digital printing and the like), by spreading, roll coating methods and the like.

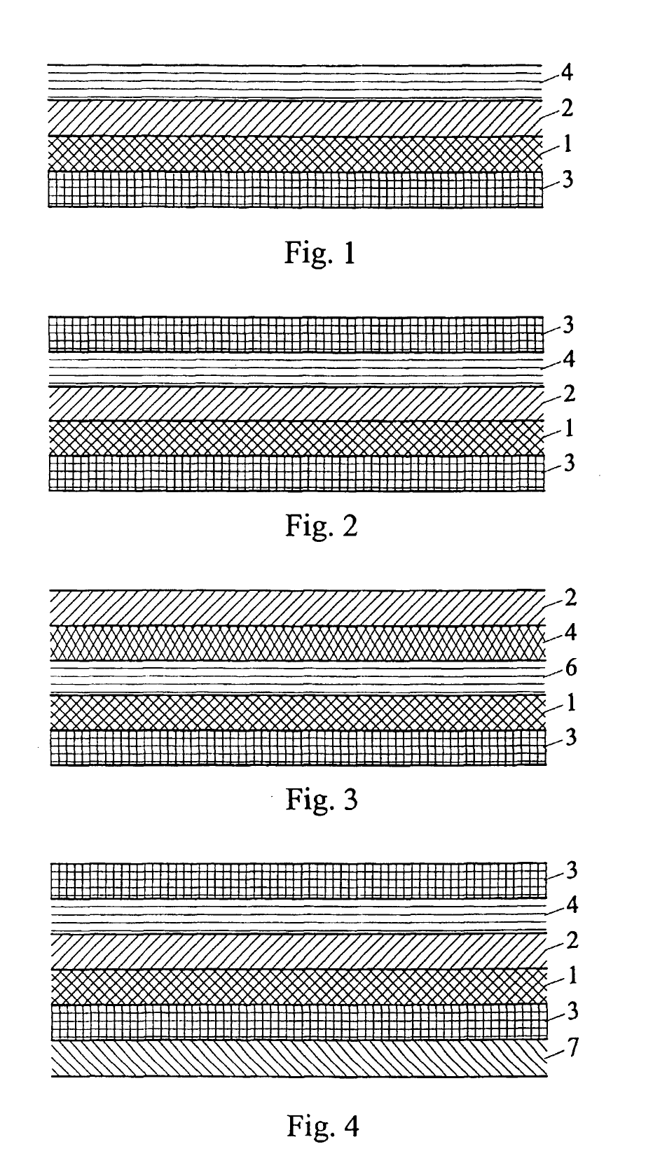

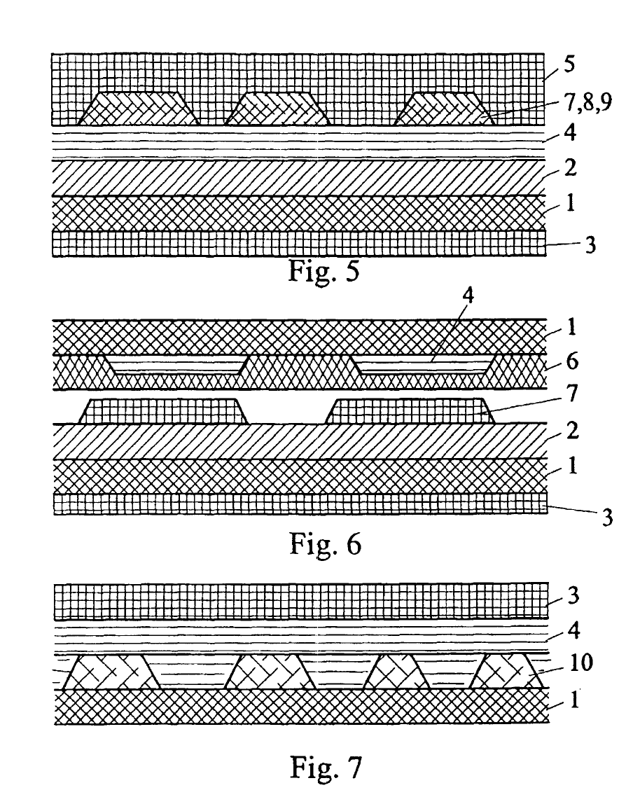

FIG. 1 to 7 depicts by example embodiments of the packaging sheet according to the invention. Therein indicate

1 the PE layer (HDPE, LDPE, LLDPE),
2 the PP layer,
3 the hot seal layer,
4 the metallized layer,
5 a protective lacquer layer,
6 a lamination adhesive layer,
7, 8, 9 a functional layer,
10 an imprint.

The thickness of the total system can be between 10 and 150 μm, preferably between 20 and 50 μm.

The required oxygen permeability of the layers is preferably settable to between 50 and 2500 ccm/m²/d, especially preferred between 200 and 1500 ccm/m²/d, and the vapor permeability between 0.5 and 10 g/m²/d, especially preferred between 2 and 5 g/m²/d, depending on the thickness of the sheet system or of the pigments utilized in the discrete layers. The oxygen permeability should be limited within the specified range, since the grain products should be packaged, on the one hand, such that they are durable and, on the other hand, escape of the odorous substances should be made possible without impairing the flavor and aroma substances.

A further advantage of the packaging according to the invention is the high metallic gloss with high attractivity, the scratch and crease resistance of the metallization, and therewith the excellent capability of storage and stackability, and the distensibility of the packaging sheet, as well as the high puncture resistance for coarse and angular bulk goods.

### EXAMPLE 1

Onto an HDPE coextrusion sheet of 3 different HDPE layers are vapor-deposited by means of vacuum vapor deposition onto one side 25 nm aluminum utilizing an inline plasma pretreatment. Utilizing gravure printing onto the backside a seal lacquer is subsequently applied, which at a temperature of 80° C. becomes sealed against itself and, after the sealing, can be separated with low expenditure of energy. In a further step onto the metallization are applied 3 g/m² NC-based protective lacquer utilizing gravure printing. This system has an oxygen, and therewith odor substance transmission, on average of 200 ccm²/d, a water vapor transmission of 0.7 g/m²/d, and a gloss value of 45 at 60° (according to DIN 67530).

### EXAMPLE 2

Onto a coextrusion sheet of Surlyn, HDPE and PP are vapor deposited on one side 10 nm aluminum by means of vacuum vapor deposition utilizing an inline plasma pretreatment. A thin transparent lacquer layer having a content of 0.2% curcuma substance and an application weight of 0.3 g/m² is subsequently applied, which is not crosslinked, in order to permit contact of the germicidal substance with the germs coming into contact with the packaging. Thereon are imprinted in gravure printing 2.5 g/m² of a protective lacquer filled with 10 percent by weight of nanotubes. This system has on average an oxygen, and therewith odorous substance, transmission of 1000 ccm/m²/d, and a water vapor transmission of 2 g/m²/d.

1. Packaging sheet suitable for packaging of grain products and their preparations, wherein that the packaging sheet is comprised of a multilayered system comprising a hot seal layer, an HDPE layer and optionally a polypropylene layer, wherein the side facing away from the hot seal layer has a metallized barrier layer.

2. Packaging sheet as claimed in claim 1, wherein a metallized coextrusion sheet is utilized for the production of the packaging sheet, wherein the PE core is provided on one side with a hot seal layer and, on the other side, is optionally provided with a polypropylene layer, which is metallized.

3. Packaging sheet as claimed in claim 1, wherein a PE sheet is laminated with a polypropylene sheet by means of a lamination adhesive, wherein the polypropylene sheet may already be metallized or is subsequently metallized, and onto the PE sheet a hot seal layer is applied.

4. Packaging sheet as claimed in claim 1 wherein the PE layer an HDPE, an LDPE or an LLDPE layer is utilized.

5. Packaging sheet as claimed in claim 1 wherein the packaging sheet comprises additionally radiation-absorbing and/or electrically conductive coatings applied over the entire surface or partially.

6. Packaging sheet as claimed in claim 5, wherein the packaging sheet comprises microwave-absorbing layer(s).

7. Packaging sheet as claimed in claim 1 wherein the packaging sheet carries an imprint in the form of symbols, patterns or letters.

8. Packaging sheet as claimed in claim 1 having a gloss value according to DIN 67530 of >40 at 60°.

9. A method for packing dried bulk goods which comprises employing the packaging sheet of claim 1 therefor.

10. The method of claim 9 wherein the dried bulk goods are grain products, dried and/or roasted fruit or seeds, cores, kernels or tuber crop preparations.

11. The method of claim 10 wherein the dried bulk goods are cereals, nuts, corn kernels or potato chips.
